(19) United States
(12) Patent Application Publication
(10) Pub. No.: US 2010/0145703 A1
(43) Pub. Date: Jun. 10, 2010

(54) Portable Code Recognition Voice-Outputting Device

(75) Inventor: Min-Cheol Park, Yongin-city (KR)

Correspondence Address: HAMRE, SCHUMANN, MUELLER & LARSON, P.C., P.O. BOX 2902, MINNEAPOLIS, MN, 55402-0902, US

(73) Assignee: Voiceye, Inc., Seoul (KR)

(21) Appl. No.: 11/884,972

(22) PCT Filed: Mar. 10, 2005
(86) PCT No.: PCT/KR05/00686

§ 371 Date: Apr. 9, 2008

(30) Foreign Application Priority Data
Feb. 25, 2005 (KR) 10-2005-0015735

(51) Int. Cl. G10L 13/08; G06K 7/10; G06F 17/30

(52) U.S. Cl. 704/260; 235/375; 704/E13.001; 707/802; 707/E17.044

(57) ABSTRACT

The present invention relates to a code recognition voice-outputting device, in which a digital code image of a predetermined compression type is recognized, and the recognized image is converted into voice to be output to the outside. The apparatus includes a reader as a scanning unit for recognizing a compressed digital code image, and a player for processing the digital code image read from the reader, and converting the processed code image into voice to be output to the outside, wherein the reader and the player are configured to be capable of being separated from each other. The present invention further provides a code recognition voice-outputting device which supports a variety of functions and provides a voice guide function for all menus and operating statuses that support the functions for the sake of eyesight handicapped, illiterates, the aged, etc., thereby promoting user convenience.

### TECHNICAL FIELD

The present invention relates to technology for voice-synthesis outputting device, and, more particularly, to a portable code recognition voice-synthesis outputting device which is capable of reading printout of a certain compressed code and of outputting the readout thereto with a voice.

### BACKGROUND ART

With development of information communication technology, information is shared among individuals and members of society nationwide, however, socially disadvantaged groups, such as the handicapped, the old, and the illiterate, have difficulty to access and use information communication such that they cannot enjoy advantages therefrom.

Most of advanced countries make efforts to provide products and services for information communication to users considering accessibility of the handicapped and the old. Also, such advanced countries require that manufacturers of information communication devices and service providers should allow the handicapped to access and use their information communication devices and services.

With such international trend, the Republic of Korea is concerned about such an issue, but the manufacturers who develop products and the service providers have passive attitudes because such obligations do not comply with their company profits.

Especially, visually impaired persons are restricted to access various information of modern information society or screened from various information of modern information society. The illiterate have the most difficulty to access such information.

The visually impaired person can read books with Braille or can access audio books. However, in order to manufacture books with Braille, it takes much time to input contents and to perform proofreading. The Braille book has disadvantages in that reading speed for the Braille is slower than that for printed characters and its volume is relatively large such that it can occupy a large space.

Also, audio books have drawbacks in that their manufacture period is relatively long and they cannot be kept for a relatively long time. Therefore, persons who have to access such voice-recording books have difficulty to collect information in the information society, compared with non-handicapped persons.

The blind can access various indirect experiences through reading a book. In order to overcome limitation of reading and writing, handicapped persons are sufficiently educated via reading education, in this way the blind can extend their experiences and have chances to access information.

In the light of such situations, there is need to develop apparatuses which can help the blind and the old access various information media without other people's help.

According to such demands, a code recognition voice synthesis apparatus, which compresses characters on the basis of a certain code and records them, has been developed and sold on the market. Therefore, the blind and the old can easily read books themselves.

The present invention relates to a voice-synthesis outputting device which is capable of recognizing the compressed code and of outputting the recognized result thereto through a voice.

In general, an exemplary example of output materials having code types is a bar code which indicates a symbol to provide information using an array of parallel bars and spaces.

Namely, such a bar code is a symbol which is encoded to optically easily read information according to the rules defined by a symbology as a bar code language. The bars and spaces are decoded to one binary bit or a plurality of binary bits according to widths thereof, and combination of the bars and spaces expresses ASCII characters.

Here, the expressed characters express figures and letters according to the kinds of bar codes.

Since such a bar code easily encodes data and has a relatively small error rate when the data are encoded, it can be configured in a data process system and printed in various materials. Therefore, the bar code can be widely used in various fields including an identification function for goods indicating a country code, a manufacturer, a product code, production date, etc.

However, the bar code has disadvantages in that symbols can inevitably include limited amount of information, such as a country code, a manufacturer, product code information, or various information cannot be expressed, and it is hard to retrieve information when the symbols are damaged.

Therefore, since it is difficult to encode large amounts of documents, such as books, using the bar code, research into various symbols has been performed so as to represent a large amount of information with the symbols. Recently, various types of digital code images have been researched and used.

### DISCLOSURE

### Technical Problem

Therefore, it is an aspect of the invention to provide a portable code recognition voice-synthesis outputting device which is capable of recognizing digital code images of a certain compressed code format, of synthesizing the recognized result with a voice, and of outputting the synthesis result.

Additional aspects and/or advantages of the invention will be set forth in part in the description which follows and, in part, will be obvious from the description, or may be learned by practice of the invention.

### Technical Solution

In accordance with an aspect of the present invention, the above and other objects can be accomplished by the provision of a portable code recognition voice-synthesis outputting device including a reader, as a scanner, for recognizing compressed digital code images, and a player for processing code images read by the reader, synthesizing the processed result and outputting the synthesizing result with a voice, in which the reader and the player are separated from one another.

In accordance with another aspect of the present invention, there is provided to a portable code recognition voice-synthesis outputting device which can provide various functions to users such that the users can easily use the device, considering the primary users, such as the blind, the illiterate, and the old, in which the various functions include a voice output function for a text file, an MP3 playing function, a recording function, an FM radio function, a clock function, etc., a voice guide function is provided for all menu and operation states.

### ADVANTAGEOUS EFFECTS

As appreciated through the above aspects, when corresponding contents of books, documents, etc., are printed based on each page thereof, since only digital code image including the contents can be printed, the device of the present invention can convert corresponding image to a voice such that the users can hear the voice. Therefore, the blind as well as the illiterate and the old can easily access information.

Also, since the reader and the player are connected to each other through USB communication and they can be separated from each other as occasion demands, the users can put the player in a pocket or a certain position and handle only the reader for performing capture to execute a capture play mode.

In addition, since the user key interface is relatively simple and easily handled by users, and all menu and operation states are informed to the users via a voice, the blind and the old can easily use the device.

### DESCRIPTION OF DRAWINGS

These and/or other aspects and advantages of the invention will become apparent and more readily appreciated from the following description of the embodiments, taken in conjunction with the accompanying drawings of which:

FIG. 1 is a perspective view of a portable code recognition voice-synthesis outputting device according to the present invention;

FIG. 2 is a schematic block diagram of a reader and a player according to the present invention;

FIG. 3 is a display printout of a digital code image according to the present invention;

FIG. 4 is a flow chart describing an execution process of a play mode according to the present invention; and

FIG. 5 is a flow chart describing an executing process of a capture play mode according to the present invention.

### BEST MODE

The portable code recognition voice-synthesis outputting device according to the present invention includes a reader for reading a digital code image of a certain compressed format, and a player for decoding information read by the reader and outputting the decoding result thereto in a certain voice, in which the player is connected to the reader through a wired/wireless network interface means.

The reader includes: an image scan means for capturing the compressed digital code image; and a wired/wireless network interface means for transmitting the captured data to the player.

The player includes: a network interface means for receiving data from the reader; a voice synthesis processing means for determining operation modes according to states as to whether a user key input is inputted and whether the reader are connected to one another, for decoding data according to program process which is stored in a program memory means, in which the data are inputted through the reader according to the operation mode, and for performing voice-synthesis process for the decoded data, based on a voice synthesis value stored in a program memory means, to create voice-synthesis data, or performing voice-synthesis process for a text file stored in a memory means for data storage, based on a voice synthesis value stored in the program memory means, to create voice synthesis data; the program memory means including a program in which processes are set, in which one process decodes the data inputted through the reader and synthesizes voice according to a voice value of each of stored data, and another process performs operation mode conversion and a voice guide for operation states; a data storing memory means for storing the decoded data (the text file); a voice output means for outputting voice synthesis digital information in a voice format, in which the voice synthesis digital information is generated through the voice synthesis processing means; a user key input means through which a user adjusts volume and mode conversion, etc., such that the player can be manipulated; a computer network interface means for connecting a computer with a network to administrate data in the player and to receive certain text information from the computer; and a power controlling means for providing drive power to the player.

### MODE FOR INVENTION

Reference will now be made in detail to the embodiments of the present invention, examples of which are illustrated in the accompanying drawings.

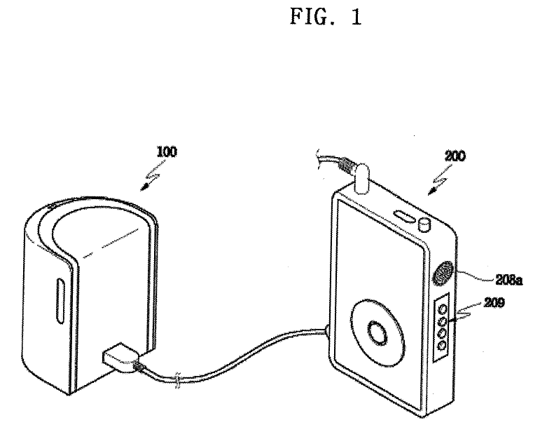

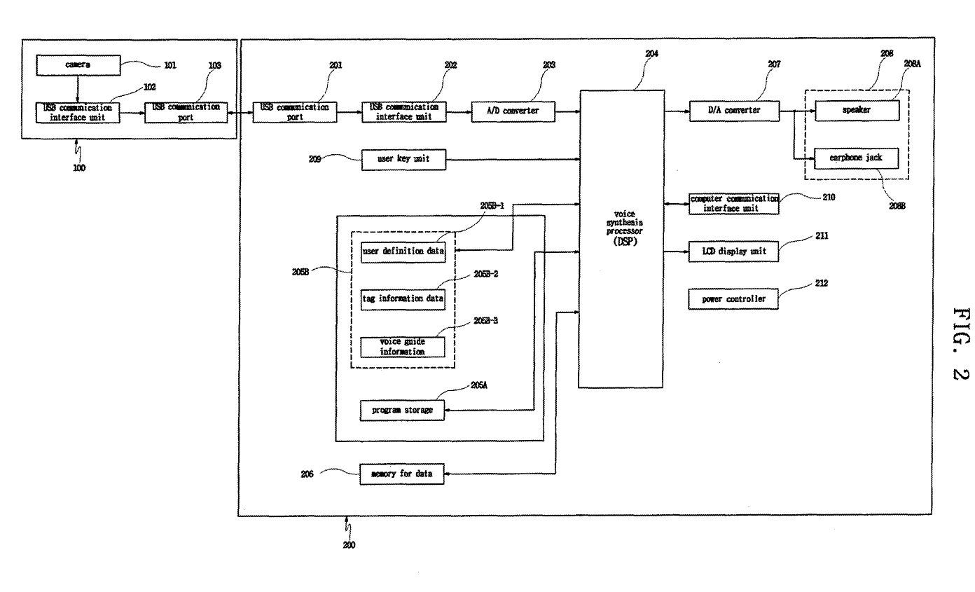

FIG. 1 is a perspective view of a portable code recognition voice-synthesis outputting device according to the present invention. FIG. 2 is a schematic block diagram of a reader and a player according to the present invention.

The portable code recognition voice-synthesis outputting device includes a reader 100 for reading a digital code image of a certain compressed format, and a player 200 for decoding information read by the reader 100 and outputting the decoding result thereto in a certain voice, in which the player 200 is connected to the reader 100 through a wired/wireless network interface means.

The reader 100 includes: a camera 101 for capturing the compressed digital code image; and a USB communication interface unit 102 for transmitting the captured information from the camera 101 to the player 200 through a USB communication port 103.

The player 200 includes: a USB communication interface unit 202 for receiving data from the reader 100 through a USB communication port 201, in which the USB communication interface unit 202 has the USB communication port 201 connected to the USB communication port 103; an A/D converting unit 203 for converting the captured data to digital data to perform a voice-synthesis process for the data; a voice synthesis process controller (DSP) 204 for determining an operation mode (for example, a capture play mode, and a play mode) according to a state whether a user key is inputted thereto or the reader 100 is connected thereto, for decoding the data according to program processes stored in a program memory 205, in which the data is captured by the reader 100 according to the operation mode, for performing voice-synthesis process for the decoded data, according to a voice synthesis value stored in the program memory, to create voice synthesis data, and for performing voice-synthesis process for a text file stored in a data storage memory 206 according to a voice synthesis value stored in program memory 205, to create voice synthesis data; the program memory 205 including a program in which processes are set, in which the processes decode the compressed digital image of the voice synthesis process controller 204 and perform voice synthesis for the decoded data, and the processes for informing an operation mode conversion and operation states with a voice; a data storing memory 206 for storing the decoded data file and a file transmitted for a computer (PC); a D/A converting unit 207 for converting voice synthesis information outputted from the synthesis process controller 204 to analog data for voice output; a voice outputting unit 208 for outputting the voice synthesis information, which is converted to the analog data in the voice synthesis process controller 204, to the outside with a voice; a user key input unit 209 through which a user adjusts volume and mode conversion, etc., such that the player can be manipulated; a computer communication interface unit 210 for administrating data of the player 200 and inputting text information from the computer (PC), in which the computer communication interface unit 210 is connected to the computer (PC); an LCD display unit 211 for displaying operation states of the reader 100 and the player 200, and for displaying a file searching screen of the player; and a power controller 212 for providing drive power to the player 200.

The voice synthesis process controller (DSP) 204 includes: a character conversion unit 204A for decoding digital code images, which are captured through the reader 100, according to decoding information stored in the program memory 205 and for converting the decoding result to characters (text); a voice synthesizing unit 204B for converting the converted character information to voice information according to voice synthesis information which is set in the program memory 205; and a mode setting unit 204C for setting operating modes of the player 200 according to the user's selection.

The program memory 205 includes a program storing unit 205A for storing a voice synthesis process program which is related to decoding information for decoding compressed digital images and to decoded data, and for storing program outputting guide messages which are related to mode conversion and operation states; and a DB storing unit 205B for storing data which serves to perform conversion (TTS) from the decoded character data (text) into a voice.

The DB storing unit 205B is configured such that it can further include a user defined data storing unit 205B-1 in which voice conversion data for symbols, figures, characters, etc., which are set by the user, are stored.

The DB storing unit 205B is configured such that it can further include a tag information storing unit 205B-2 in which tag information indicates voice color, speech speed, voice tone, etc. when voice including digital code images is outputted.

Also, the DB storing unit 205B is configured such that it can further include a voice guide storing unit 205B-3 for notifying a user of notification voice message information.

The voice outputting unit 208 is configured such that voice output data, which is converted through the D/A conversion unit 207, is amplified and outputted to a speaker 208A or an earphone jack 208B.

As such, the present invention is configured to include the reader 100 and the player 200. The reader 100 and the player 200 include USB communication interfaces 102 and 202 as a data communication interface means, respectively, such that they can exchange data through USB communication, and also include USB communication ports 103 and 201 for communication with each other.

Here, although the embodiment of the present invention implements the reader 100 and the player 200 such that they can form network based on USB communication, it can be modified to adopt various wired/wireless communication means which can perform Bluetooth communication, serial communication, etc.

Considering the blind or the old as the primary users, the reader 100 and the player 200 can be manufactured such that their sizes are small. Also, the reader 100 and the player 200 are configured such that they are connected to each other based on USB communication, and a capture operation can be easily performed even if a user only handles the reader 100.

Also, the player 200 includes a computer communication interface unit 210 to form network with the computer, in which the computer communication interface unit 210 can be implemented to perform USB communication. On the other hand, the player 200 can be configured to perform data communication with the computer through the USB communication interface unit 102 and the USB communication port 103, which communicate with the player 200, without an additional computer communication interface unit 209 and communication port 209a therefor.

Here, the network between the computer and the player can be implemented with various communication connection means.

The player 200 includes a program memory 205 which provides a process for performing a voice synthesis process for digital images captured through the voice synthesizing process controller 204, in which the program memory 205 includes a program storing unit 205A and a DB storing unit 205B.

The program storing unit 205A stores a series of processes for performing a voice synthesis process for captured digital code images, and the DB storing unit 205B stores voice information values corresponding to the decoded digital code images.

As such, the DB storing unit 205B inputs information for performing a voice synthesis for the decoded digital code images, and is configured to include a user defined data storing unit 205B-1 through which a user can designate an output value for a certain corresponding character.

The user defined data serves to provide user definition functions such that particular character string (which includes figures, symbols, foreign language, etc.) can be read as a user desired. A user inputs information necessary for the user definition functions to the user defined data storing unit 205-1 through the user key input unit 209.

Also, the DB storing unit 205B includes a tag information storing unit 205B-2.

The digital code images may include tags for designating voice color, speech speed, voice tone, etc.

Therefore, definition for tag information to execute such tags must be recorded.

The data storing memory 206 stores data as a text file, in which the data is converted to text for voice synthesis output. The stored file can be played with a voice as occasion demands. Here, since the data storing memory 206 has data storage capacity limitation, it can be configured to further include a data memory such that an extended data memory can be used thereto.

Also, the DB storing unit 205B stores voice synthesis information according to voice output modes which can be selected through the user key input unit 209. Therefore, various voices, such as a woman's voice, a man's voice and, a refresh feeling voice and an entertainer's voice for reading articles, etc. can be outputted according to the voice output mode.

The player 200 includes an LCD display unit 211 to display a file searching state and operation states of the reader 100 and the player 200. Also, the player 200 is configured such that voice guide messages for a designated folder and file and voice guide messages according to conversion operation states of each mode can be outputted thereto such that the blind or the illiterate can recognize the operation state of the player 200.

The user key input unit 209 is installed to an external side of a case of the player 200 such that the blind or the old can easily input keys thereto. Therefore, conversion of each mode, and switch operations for controlling a volume, etc. can be easily performed according to a key selection sequence.

On the other hand, keys can be implemented to etch Braille points thereon, such that the users can easily recognize contents on the keys.

Based on the above-described configuration, operations of the present invention will be described in detail below:

The device according to the present invention serves to capture digital code images (hereinafter referred to as a voice-eye code) which are printed on documents or published books, and to synthesize the captured information with a voice, such that it can allow users to hear them.

The device according to the present invention can be operated in a state where the voice eye code storing compressed contents of texts, which are printed on documents or published books, must be printed.

Here, the voice eye code is printed on upper or lower end portions of a book such that the blind can easily access its positions.

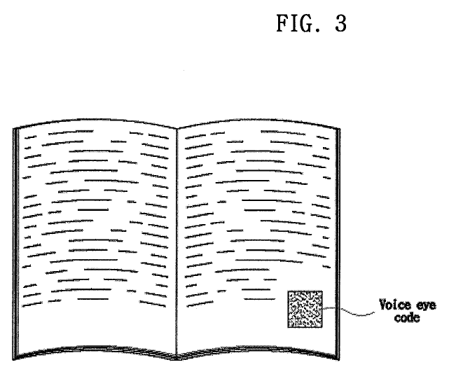

FIG. 3 is a display printout of a digital code image according to the present invention.

As shown in FIG. 3, the printed voice eye code is captured to allow users to hear its text information with a voice.

Firstly, the following is a schematic description for operations of the above procedure.

A capture play mode is performed in a state where the reader 100 and the player 200 are connected to each other.

When documents are captured using the reader 100, the voice eye code is captured as the reader 100 is manipulated in a state where the reader 100 and the player 200 are connected to one another.

Namely, the camera 101 of the reader 100 reads a voice eye code to transmit the read information to the player 200 through the USB communication port 103 and the USB communication port 201 of the player 200.

The A/D conversion unit 203 of the player 200 converts the received captured analog image to digital data to transmit the digital data to the voice synthesis process controller 204.

The voice synthesis process controller 204 recognizes the inputted digital image data to convert it to a certain character, and then synthesizes the converted character information with a voice to create voice information to be outputted.

The voice synthesis process controller 204 is operated such that the inputted voice eye code information is converted to characters according to decoding information of the voice eye code which is stored in the DB storing unit 205B through a character conversion unit 204A.

After converting to the characters, the voice synthesis unit 204B performs voice synthesis for the respective converted characters using a voice synthesis value corresponding to the characters stored in the DB storing unit 205B, and then creates voice information to be outputted.

Here, when there appear characters corresponding to a user definition value which is defined in the user defined data storing unit 205B-1, a voice synthesis value is determined by the defined user value.

Also, when a tag exists in converted characters, a corresponding tag value is recognized in the tag information storing unit 205B-2 to create voice information according to a command designated by the tag.

The created voice information is converted analog voice data for voice output through the D/A conversion unit 207, and then amplified through the voice output unit 208 to output a voice to the outside through the speaker 208A or the ear phone jack 208B, which are installed to the external side of the player case.

On the other hand, the voice synthesis process controller 204 stores decoded voice information as a text file to the data storing memory 206 according to a user setting mode which is set in the mode setting unit 204C, such that users can play and repeatedly hear the decoded voice information.

The user can set automatic storage and an automatic storage mode for performing storage as occasion demands or set selection storage, through the user key input unit 209.

The following is a description for operations of the device according to the present invention based on their modes.

Operation mode of the player 200 is performed by a state of whether or not the reader 100 is connected thereto, and by user's selection through the user key input, unit 209.

Operation modes are determined on the basis of determination as to whether the reader 100 is connected thereto. When the reader 100 is connected thereto, it is operated in a capture play mode, and when the reader 100 is not connected thereto, it is operated in a play mode to play a file stored in the data storing memory 206.

However, when mode conversion is attempted through a mode conversion key of the user key input unit 209, it is operated in a corresponding operation mode based on user selection, which is given priority, regardless of a state of whether or not the reader 100 is connected thereto.

When the mode conversion key of the user key input unit 209 is selected to designate a capture play mode, a determination as to whether the reader 100 is connected thereto is performed.

When the reader 100 is connected thereto, a guide message is read in the voice guide information storing unit 205B-3 and then outputted with a voice to allow the user to hear the voice corresponding thereto.

For example, a voice guide message “The Reader Is Not Connected” is transmitted.

Afterwards, when the reader 100 is connected to the player 200, a message “The Reader Is Connected” is outputted to the user, with a voice, to inform them that a capture play mode can be performed.

As such, when the reader 100 and the player 200 are connected to one another in a state where the capture play mode is set, the capture play mode is automatically performed. In this case, it does not require any additional operation for instructing capture.

Namely, a capture command key is not needed therein.

When a voice eye code is read as the reader 100 is manipulated, it is converted to characters by the character conversion unit 204A and then stored as a text file in a buffer. Afterwards, it is synthesized with a voice in the voice synthesis unit 204B and then outputted in real-time with a voice.

After completing all capture play procedures, when a stop key is selected by a user, the capture play mode is finished. Afterwards, when a voice message is notified to the user as to whether voice output information outputted till that time is stored, the user can determine as to whether the information is stored.

When the user selects a storage key, the converted character file-text file is stored in the data storing memory 206. On the other hand, when the user does not select the storage key, the contents of the memory buffer is deleted.

Here, the voice synthesized information can be stored therein while it is played. Therefore, when the user selects a save key, a text file temporarily stored in the memory buffer is stored in the data storing memory 206 while a beep is outputted.

While a voice synthesis outputted file is stored, a voice synthesis output continues until the user executes a stop key.

Also, when a user has set an automatic storing mode, it is automatically stored without confirmation as to whether it is to be stored.

Such a storing method will be described briefly as follows.

When a book is decoded, a folder is automatically created in the voice eye book as a book title which is defined in the header of the voice eye code, a file having a format “page number of book.txt” is stored in the folder. Here, the files displayed on the LCD display unit are sorted based on file names.

Here, the files in the designated book folder are set such that the computer (PC) cannot access thereto so as to protect copy right.

Namely, when contents of a book are previously compressed and encoded, data notifying encoding for a book in the header is included. Therefore, as the information is included therein when the contents are decoded and stored therein, the copy right can be protected.

With regard to general documents, not books, the documents in a format of name+pagenumber.txt are stored in another folder (voiceeye) according to a set name determining method.

Here, administration is performed by a user, such that the user can create sub folders through the computer (PC).

The decoded documents are entitled according to their kinds and stored on the basis of a certain rule.

Regarding selection of a play mode:

When the play mode is selected by a user, a searching screen is displayed on an LCD display, such that the user can select his/her desired file through the searching screen and perform voice play thereof to hear a voice.

Since the play mode is related to voice output of a text file stored in the data storing memory 206 regardless of connection of the reader 100, it does not determine a state as to whether the reader 100 is connected thereto.

Here, since a folder and a file are notified to a user with a voice as the user designates the folder and the file to be searched, the user can play information, which is stored in the data storing memory 206 and previously captured and converted to voice information, while the user hears a guide voice, and then hears a voice of the played information.

When an additional user play mode conversion is not performed, a capture play mode becomes a basic operation mode. Here, the capture play mode serves to perform a voice synthesis for a voice eye code in which a state of connection between the reader 100 and the player 200 is captured, and then to output the voice in real time. When a play mode becomes a basic operation, in which the play mode plays a state in which the reader 100 and the player 200 are not connected to one another, the player 200 is basically operated in a play mode at the first power on state (a reset state) as the user selects a play mode conversion in a state where the reader 100 is connected thereto.

In this case, a play mode in which processes search for play files is proceeded such that designation, display and search can be performed from the recently played text file of text files stored in the data storing memory 206.

On the other hand, as the text files, which are stored in the data storage memory 206 through the above-described capture play mode, are accessed by the computer or the text files are received from the computer (PC), to perform voice synthesis for the text files, voice play for the text files can be performed.

The player 200 is connected to a computer to transmit/received data to/from the computer. Namely, the player 200 can be connected to the computer through USB communication such that the folders and the files in the player 200 can be administrated.

Also, the text files in the computer (PC) are transmitted to the player 200, such that a voice synthesis function of text files, which outputs a voice to the outside, can be performed, using a voice synthesis output function supported by the player 200.

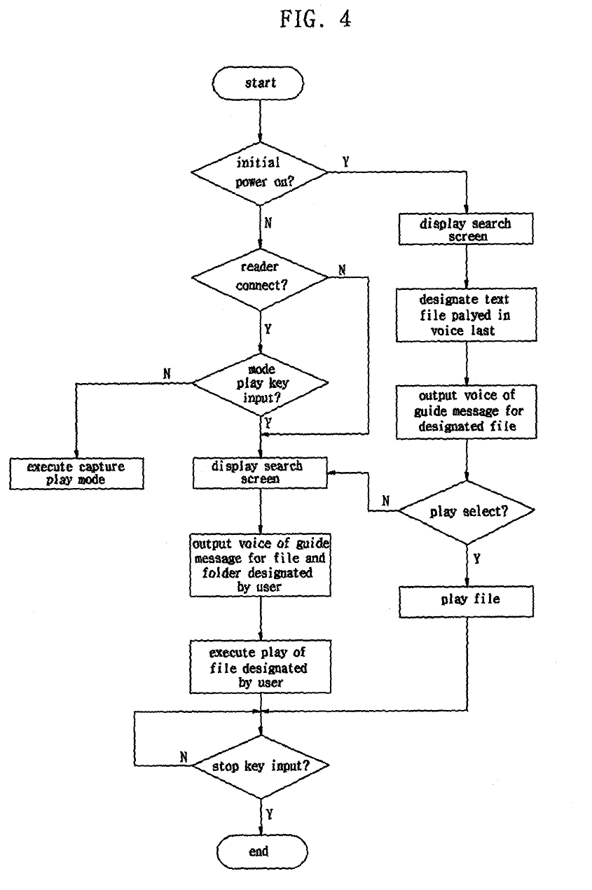

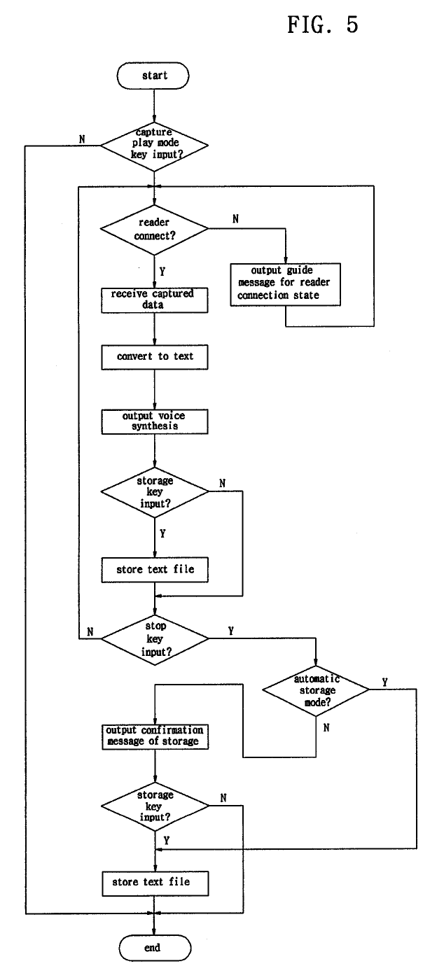

FIG. 4 is a flow chart describing an execution process of a play mode according to the present invention. FIG. 5 is a flow chart describing an executing process of a capture play mode according to the present invention.

The execution process includes a capture play mode execution process and a play mode execution process.

Firstly, the capture play mode execution process includes the following processes:

When a capture play mode is selected, a reader connection determination process is performed such that a guide message notifying that the capture play mode was selected is outputted with a voice, and then a determination is performed as to whether the reader is connected thereto.

When the reader is not connected thereto based on the determination result of the reader connection determination process, a reader state guide message output process is performed such that a guide message, which notifies a connection state of the reader, is outputted thereto to allow the reader to connect thereto.

When the reader is connected thereto, a character conversion process is performed such that the captured image is received and the received image is decoded to a text.

A voice information creation process is performed such that voice information to be outputted is created from characters, which are converted according to a voice output mode set by a user, using set voice synthesis value.

A voice outputting process serves to output the created voice information to the outside with a voice.

Secondly, the play mode execution mode includes the following processes:

When a play mode is selected, a play selection process is performed such that a guide message notifying that the play mode was selected is outputted with a voice, a search screen is displayed such that a stored file can be searched, and a guide message for the folder and file designated by the user is outputted with a voice.

A voice information creation process is performed such that voice information to be outputted is created using a voice synthesis value for the file which is selected by the user to play the file.

A voice output process serves to output the created voice information to the outside with a voice.

On the other hand, the capture play mode execution further includes a reset determination process for determining as to whether the first power is on, and the play mode execution process which is performed such that a guide message notifying that a play mode is performed is executed regardless of a state whether the reader is connected when the first power is on, based on the result of the reset determination process.

Also, the capture play mode may further include a process in which the capture play mode can be executed according to a state whether the reader is connected thereto, and can be performed by a corresponding mode converted by the user when a user mode conversion key is inputted.

In addition, when a capture play is completed by a user stop key input, the capture play mode may further include the step of determining a state as to whether it is an automatic storing mode, and completing processes in which decoded text file in the data storing memory is stored therein when it is in an automatic storing mode, confirmation is performed for a state as to whether the decoded text file is stored by a user when it is not an automatic storing mode, and the decoded text file is stored according to user's selection.

On the other hand, the present invention includes various functions to provide convenience of use to the blind, the illiterate, and the old.

Firstly, the player according to the present invention may further include a decoding means for MP3 files to provide an MP3 file play function.

The player according to the present invention may include a radio tuner as a receiving means for receiving radio signals such that they can hear FM radio broadcasts.

Also, the device according to the present invention may further include an encoder which can convert analog voice data inputted through the voice input means into digital data to store a certain compressed file (MP3). Here, the user's voice can be recorded to a file.

Afterwards, a radio output voice can be recorded in MP3 using the encoder when the user desires hearing radio broadcast, as occasion demands.

Also, the voice synthesis process controller can store outputted voice information in a compressed file format (MP3) using the above-described encoder. On the other hand, the voice information may be stored therein in a compressed file format not a text format.

The device according to the present invention may be configured to further include corresponding encoders to selectively covert file formats or to further include corresponding file format conversion means to convert file formats, such that it can covert voice synthesized information to user's designated output formats (PCM, WAV, ASF, MP3, etc.) and store them in a data storing memory or transmit them to a computer (PC).

Also, since the present invention provides a voice guide function for all menu and operation states, it is configured to include a clock system. The clock system displays time on an LCD display unit and allows time in a voice to be notified per a predetermined period, the present invention can provide convenience of use to users.

Although a few embodiments of the present invention have been shown and described, it would be appreciated by those skilled in the art that changes may be made in these embodiments without departing from the principles and spirit of the invention, the scope of which is defined in the claims and their equivalents.

1. A portable code recognition voice-synthesis outputting device comprising: a reader for reading a digital code image of a compressed format; and a player for decoding information read by the reader and outputting the decoding result with a certain voice, in which the player is connected to the reader through wired/wireless network interface means, wherein the reader includes: an image scan means for capturing the compressed digital code image; and a wired/wireless network interface means for transmitting the captured data to the player, wherein the player includes: a network interface means for transmitting/receiving data to/from the reader or a computer; a voice synthesis process control means for decoding data according to program process which is stored in a program memory means, in which the data are inputted through the reader according to the operation mode, and for performing voice-synthesis process for the decoded data, based on a voice synthesis value stored in a program memory means, to create voice-synthesis data, or performing voice-synthesis process for a text file stored in a memory means for data storage, based on a voice synthesis value stored in the program memory means, to create voice synthesis data; the program memory means including a program in which processes are set, in which one process decodes the data inputted through the reader and synthesizes voice according to a voice value of each of stored data, and another process performs operation mode conversion and a voice guide for operation states; a data storing memory means for storing the decoded data (the text file); a voice output means for outputting voice synthesis digital information in a voice format, in which the voice synthesis digital information is generated through the voice synthesis processing means; a user key input means through which a user adjusts volume and mode conversion, etc., such that the player can be manipulated; a display means for displaying operation states of the reader and the player and displaying a file searching screen of the player; a power controlling means for providing drive power to the player; and a data conversion means for converting data inputted to the voice synthesis process control means into digital data, and for converting voice data outputted from the voice synthesis process control means into analog data.

2. The device as set forth in claim 1, further comprises a computer network interface means for connecting a computer with a network to administrate data in the player and to receive certain text information from the computer.

3. The device as set forth in claim 1, wherein a voice synthesis process control means includes: a character conversion unit for decoding digital code images, which are captured through the reader, according to decoding information stored in the program memory and for converting the decoding result to characters (text); a voice synthesizing unit for converting the converted character information to voice information according to voice synthesis information which is set in the program memory; and a mode setting unit for setting operating modes of the player according to the user's selection, wherein the program memory includes a program storing unit for storing a voice synthesis process program which is related to decoding information for decoding compressed digital images and to decoded data, and for storing program outputting guide messages which are related to mode conversion and operation states; and a DB storing unit for storing data which serves to perform conversion (TTS) from the decoded character data (text) into a voice.

4. The device as set forth in claim 3, wherein the DB storing unit is configured such that it can further include a user defined data storing unit in which voice conversion data for symbols, figures, characters, etc., which are set by the user, are stored.

5. The device as set forth in claim 3, wherein the DB storing unit is configured such that it can further include a tag information storing unit in which tag information indicates voice color, speech speed, voice tone, etc. when voice including digital code images is outputted.

6. The device as set forth in claim 1, wherein the voice outputting unit includes: a means for amplifying voice output data; and a speaker 208A or an earphone jack 208B which output the amplified voice output data to the outside.

7. The device as set forth in claim 1, wherein the network interface means serves to perform USB communication interface.

8. The device as set forth in claim 1, further comprising an extended memory slot unit such that an extended data memory can be used thereto, as occasion demand.

9. The device as set forth in claim 1, wherein the voice synthesis process control means determines its operation mode on the basis of a mode conversion which is performed by user selection through user key input means or a determination as to whether the reader is connected thereto.

10. The device as set forth in claim 9, wherein the voice synthesis process control means determines the operation mode based on the user selection through the user key input means, which is given priority.

11. The device as set forth in claim 1, wherein the voice synthesis process control means reads header information from the decoded information, recognizes documents information related to copy right from the read result, stores the recognition result in a certain designated area (folder) of a data storing memory, and sets such that the computer cannot access the area when the computer is connected thereto.

12. The device as set forth in claim 1, wherein the voice synthesis process control means performs voice synthesis process control comprising a capture play mode execution process and a play mode execution process, wherein the capture play mode execution process includes: a determination process in which a state as to whether a user mode conversion key is inputted is determined; when a capture play mode is selected based on the determination result, a reader connection determination process in which a guide message notifying that the capture play mode was selected is outputted with a voice, and then a determination is performed as to whether the reader is connected thereto; when the reader is not connected thereto based on the determination result of the reader connection determination process, a reader state guide message output process in which a guide message, which notifies a connection state of the reader, is outputted thereto; when the reader is connected thereto, a character conversion process in which the captured image is received and the received image is decoded to a text; a voice information creation process in which voice information to be outputted is created from characters, which are converted according to a voice output mode set by a user, using set voice synthesis value; and a voice outputting process which serves to output the created voice information to the outside with a voice, wherein the play mode execution mode includes: when a play mode is selected, a play selection process in which a guide message notifying that the play mode was selected is outputted with a voice, a search screen is displayed such that a stored file can be searched, and a guide message for the folder and file designated by the user is outputted with a voice; a voice information creation process in which voice information to be outputted is created using a voice synthesis value for the file which is selected by the user to play the file; and a voice output process serves to output the created voice information to the outside with a voice.

13. The device as set forth in claim 12, wherein the process of the voice synthesis process control means further includes: a reset determination process for determining as to whether the first power is on; and a play mode execution process which is performed such that a guide message notifying that a play mode is performed is executed regardless of a state whether the reader is connected when the first power is on, based on the result of the reset determination process.

14. The device as set forth in claim 12, wherein the capture play mode includes a process in which the capture play mode can be automatically executed according to a state whether the reader is connected thereto, and can perform an operation mode conversion in which a corresponding mode designated by the user is performed when a user mode conversion key is inputted.

15. The device as set forth in claim 12, wherein the capture play mode further includes the step of, when a capture play is completed by a user stop key input: determining a state as to whether it is an automatic storing mode; and completing processes in which decoded text file in the data storing memory is stored therein when it is in an automatic storing mode, confirmation is performed for a state as to whether the decoded text file is stored by a user when it is not an automatic storing mode, and the decoded text file is stored according to user's selection.

16. The device as set forth in claim 1, wherein the player further includes a decoding means for MP3 files to provide an MP3 file play function.

17. The device as set forth in claim 1, wherein the player further includes a radio receiving means and a radio tuner.

18. The device as set forth in claim 1, further comprising: an encoder which can convert analog voice data inputted through the voice input means into digital data to store a certain compressed file (MP3).
